(19) United States
(12) Patent Application Publication
(10) Pub. No.: US 2010/0051725 A1
(43) Pub. Date: Mar. 4, 2010

(54) Watering tube device

(76) Inventors: Mary Beth Boyette, Wetumpka, AL (US); Carole B. Crews, Montgomery, AL (US)

Correspondence Address: Mary Beth Boyette, Suite 120, 60 Commerce Street, Montgomery, AL, 36104, US

(21) Appl. No.: 12/584,024

(22) Filed: Aug. 28, 2009

Related U.S. Application Data
(60) Provisional application No. 61/190,808, filed on Sep. 2, 2008.

(51) Int. Cl. B05B 15/00

(52) U.S. Cl. 239/542

(57) ABSTRACT

A watering tool for planting underground, directing water flow and air to the root system and surrounding area of a plant, tree, bush. A hollow tube is secured in an upright position held by a clamp like apparatus attached to the watering device. Top open end of the tube remains above ground. A flow of water is collected by the above ground portion of the tube. Back and side retaining walls on the watering device direct the liquid forward. Flow directors on the base of the device insure spillage toward the front blunt edge, then directly to the plants underground root area. Plants instantly receive water and air, eliminating evaporation and run off, as in traditional watering methods above ground.

### BACKGROUND OF THE INVENTION

1. Field of Invention

The invention relates to a device for watering plants, trees, bushes. Landscapers on all levels recognize the problem of runoff and evaporation when attempting to get water to penetrate underground. Our community resources are limited. Recognizing the waste of our water is an environmental necessity.

2. Description of Related Art

In related art, the inventions serve their purpose but soon a hole dug by an apparatus erodes eventually filling up and needs to be repeated to continue aeration. U.S. Pat. No. 3,116,019, U.S. Pat. D456,225, U.S. Pat. D447,921.

The inventions with attachment for a garden hose attempts to sprinkle water in an assortment of different ways to soak to the root system. There is still a continuous waste of our precious resource, water. U.S. Pat. D344,217, US Publication 2005/0279264.

### SUMMARY OF THE INVENTION

The present invention is a device for holding stable a hollow tube. The device and tube are buried underground near a plant or the like when it is put in the ground. The top portion of the hollow tube remains above ground, exposed to receive a liquid from rain, or garden hose. Liquid enters top opening of the tube and is expelled through the opposite end. The water device controls the flow of liquid in a forward motion. Liquid and air are directed to the root system and surrounding area. Watering is instant and without run off or excess evaporation.

### BRIEF DESCRIPTION OF DRAWING

FIG. 1 is a front view.

FIG. 2 is a front, side view.

FIG. 3 is a back view.

### A DETAILED DESCRIPTION OF THE PREFERRED EMBODIMENT

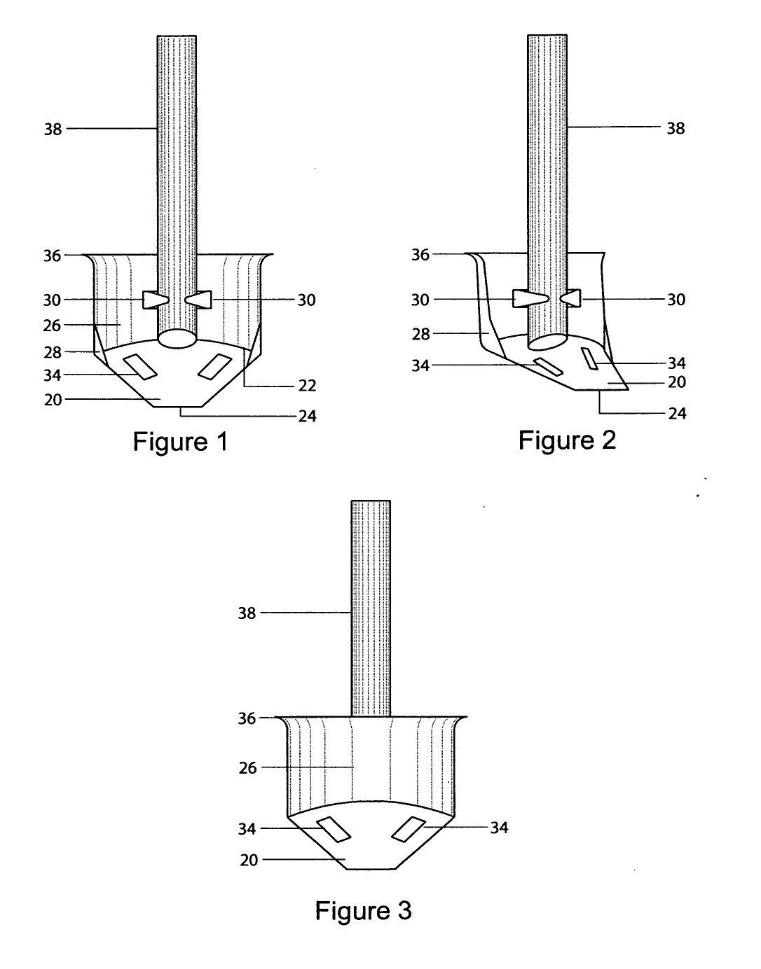

Referring to FIG. 1, a front view of the invention showing the water device base 20 having a curved back edge 22 and a blunt front edge 24. The base 20 has a back retaining wall 26 and side retaining walls 28. Showing is a clamp 30 like apparatus to secure a hollow tube 38 in an upright position. Flow directors 34 insure the forward flow of liquid expelled from the tube 38. FIG. 2 shows the back retaining wall top lip 36 for stability when the device is planted underground. The front, side view shows back retaining wall 26 contours to the curved back edge 22 of the base 20. The clamp 30 like apparatus is mounted to the back retaining wall 26. Flow directors 34 for a forward flow of liquid toward the front edge 24. FIG. 3 shows a back view of the back retaining wall 26, the top lip 24 of the back wall extending outward. Flow directors 34 indented from the bottom of the base 20. The base 20 is slightly angled downward to direct liquid flow toward the front edge 24.

### NUMBERS FOR THE DRAWINGS

20 Base
22 Base back edge
24 Base front edge
26 Back retaining wall
28 Side retaining walls
30 Clamp
34 Flow directors
36 Back wall lip
38 Hollow Tube

What is claimed is:

1. A water device for planting underground for the purpose of directing a flow of liquid and air directly to the root system and surrounding area of a plant, tree, bush or the like comprising;
a triangle shaped base with an apparatus, a curved back edge and a blunt front edge moreover;
said base has a configuration of deflectors and raised portions.

2. As in claim 1 said apparatus is a clamp like element for holding stable a hollow tube.

3. As in claim 1 said deflectors are retaining walls.

4. As in claim 3 said retaining wall is a back wall contouring to the curved back edge of said base.

5. As in claim 3 said retaining walls further include a sidewall connected to said base and said back wall, the opposite side of said device being the same.

6. As in claim 1 said raised portions are flow directors for a forward motion of liquid.
